(19) United States
(12) Patent Application Publication
(10) Pub. No.: US 2010/0303311 A1
(43) Pub. Date: Dec. 2, 2010

(54) FINGERPRINT RECOGNITION APPARATUS AND METHOD THEREOF OF ACQUIRING FINGERPRINT DATA

(75) Inventors: Yo-shik SHIN, Seoul (KR); Geum-yong KIM, Seoul (KR); Ji-Ho LEE, Seoul (KR)

Correspondence Address: STEIN MCEWEN, LLP, 1400 EYE STREET, NW, SUITE 300, WASHINGTON, DC, 20005, US

(73) Assignee: Union Community Co., Ltd., Seoul (KR)

(21) Appl. No.: 12/787,579

(22) Filed: May 26, 2010

(30) Foreign Application Priority Data
May 26, 2009 (KR) 10-2009-0045872

(51) Int. Cl. G06K 9/00

(52) U.S. Cl. 382/124

(57) ABSTRACT

A fingerprint recognition apparatus and a method thereof of acquiring fingerprint data are provided. The fingerprint recognition apparatus acquires a user's fingerprint image through a fingerprint sensor, extracts information regarding a fingerprint size, a fingerprint position, a degree of fingerprint contact and a condition of minutiae points, and displays a corresponding error message and guide information through a display unit to encourage a reinput of fingerprint, if determining that the extracted information is not within a predetermined range. As a result, the user is encouraged to input a best quality fingerprint to allow extraction of good print data for either fingerprint enrollment or authentication. The information provided to the user may practically include detailed error and guide information regarding the fingerprint size, a degree with which a fingerprint is pushed to a certain side, a degree of contact or humidity of a fingerprint.

### CROSS-REFERENCE TO RELATED APPLICATIONS

This application claims priority from Korean Patent Application No. 10-2009-0045872, filed on May 26, 2009, in the Korean Intellectual Property Office, the disclosure of which is incorporated herein by reference in its entirety.

### BACKGROUND OF THE INVENTION

1. Field of the Invention

The present invention relates to a fingerprint recognition apparatus and a method thereof of acquiring fingerprint data, capable of providing relevant information if the input fingerprint image quality is inadequate during a process of acquiring fingerprint data utilized for fingerprint recognition, enabling a user to reinput a better quality fingerprint image.

2. Description of the Related Art

Biometric recognition is popularly used in a wide range of applications mainly because of the advantages that all human beings have different biometrics such as fingerprints, irises, voices, faces, and blood vessels from each other and these are readily acquirable, there is a low possibility of plagiarism or imitation, and the biometric characteristics of a person are rarely altered.

Among many applications of the biometric recognition, the fingerprint recognition is the most widely commercialized technology due to advantages such as convenience of use, high security, and economic values.

A user authentication utilizing a fingerprint begins with the enrollment and storage of a fingerprint image from a user to use it as a fingerprint template. Accordingly, when a fingerprint image is additionally input from the user, the system compares the newly input fingerprint image with the pre-enrolled fingerprint template, and verifies the user as the enrolled user if the two fingerprint images match.

While it is always important that the user inputs good quality fingerprint images for efficient authentication, the quality of a fingerprint image initially input for template enrollment is the most important, because this heavily influences the overall authentication performance of a system. If an initially-enrolled fingerprint image is in inaccurate condition, the fingerprint authentication performance deteriorates even if the best quality matching algorithms are used. It is also not efficient to expect that each and every user would enroll a best quality fingerprint without any assistance.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a fingerprint recognition apparatus and a method thereof of acquiring fingerprint data, capable of providing a user with relevant information if a fingerprint image input in a fingerprint data acquisition process for use in fingerprint recognition has an inadequate quality, thereby enabling the user to reinput a better quality fingerprint input.

A fingerprint recognition apparatus which comprises a fingerprint sensor to acquire a fingerprint image from a fingerprint placed on a fingerprint input widow, and extracts fingerprint data based on the fingerprint image. The fingerprint recognition apparatus may include a display unit which visually displays predetermined information, and a control unit which receives the fingerprint image from the fingerprint sensor and extracts the fingerprint data accordingly, and if one of a fingerprint size, a fingerprint position, a degree of fingerprint contact, and a condition of minutiae points is not within a predetermined range, causes the display unit to display guide information including information about a corresponding error and instruction regarding a reinput of the fingerprint.

The control unit may determine a size of a fingerprint area based on the fingerprint image, and if the fingerprint area exceeds the predetermined range, causes the display unit to display a corresponding size ratio as the error information regarding the fingerprint size.

The control unit may extract a fingerprint area from the fingerprint image, generate center coordinates of the fingerprint area by computing a mean value of coordinates of each pixel of the extracted fingerprint area, and if a difference between the center coordinates of the fingerprint area and the center coordinates of the fingerprint image is not within the predetermined range, cause the display unit to display the position of the fingerprint extracted from the difference, as the error information regarding the fingerprint position.

The control unit may extract a fingerprint area from the fingerprint image, extracts all minutiae points, including both adequate and inadequate minutiae points, from the extracted fingerprint area, and if a ratio of the inadequate minutiae points in relation to the adequate minutiae points does not satisfy the predetermined range, cause the display unit to display a corresponding ratio as the error information regarding the condition of the minutiae points.

The control unit may extract a fingerprint area from the fingerprint image, divide the extracted fingerprint area into predetermined unit segments, obtain a gray tone of each unit segment, obtains the number (x1) of the unit segments with the gray tones corresponding to a reference level, the number (x2) of the unit segments with the gray tones exceeding the reference level, the number (x3) of the unit segments with the tray gone insufficient for the reference level, determines the degree of fingerprint contact to be higher than the predetermined range if (x1) is short from 50% of the total number of the unit segments and higher than (x2) and (x3), determine the degree of fingerprint contact to be lower than the predetermined range if (1) is short from 50% of the total number of the unit segments and lower than (x2) and (x3), and accordingly cause the display unit to display the error information regarding the degree of fingerprint contact.

According to an embodiment of the present invention, a method of acquiring a fingerprint image of a fingerprint recognition apparatus which registers a fingerprint using a fingerprint image acquired from a fingerprint placed on a fingerprint input window, may include acquiring the fingerprint image from the fingerprint placed on the fingerprint input window, computing a value representing a fingerprint size, a fingerprint position, a degree of fingerprint contact, and a condition of minutiae points, based on the fingerprint area extracted from the fingerprint image, if one of the computed values is not within a predetermined range, displaying through a display unit corresponding error information and guide information regarding a reinput of the fingerprint, and if all of the computed values are within the predetermined range, acquiring the fingerprint data from the fingerprint image.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a block diagram of a fingerprint recognition apparatus according to an embodiment of the present invention; and

FIGS. 2 to 5 illustrate examples in which a display unit displaying the fingerprint images acquired in a fingerprint registration process and corresponding error information.

### DETAILED DESCRIPTION OF EXEMPLARY EMBODIMENTS

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

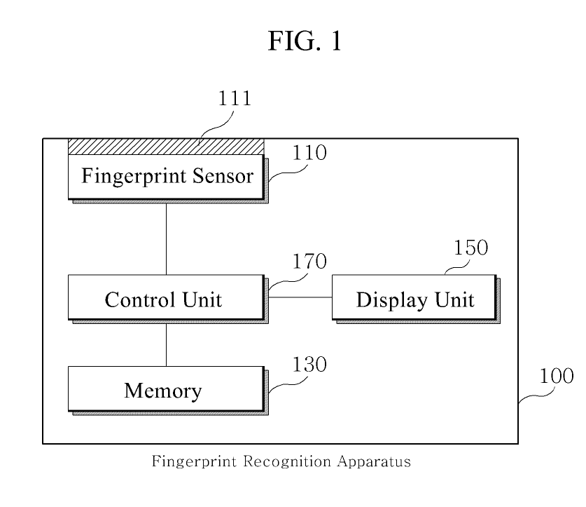

FIG. 1 is a block diagram of a fingerprint recognition apparatus according to an embodiment of the present invention. Referring to FIG. 1, the fingerprint recognition apparatus 100 according to an embodiment of the present invention may include a fingerprint sensor 110, a memory 130, a display unit 150, and a control unit 170.

The fingerprint sensor 110 acquires an image of a fingerprint placed on a fingerprint input window 111 and provides the control unit 170 with the acquired image, and may apply an optical fingerprint sensor utilizing an optical lens such as prism or hologram, or a non-optical fingerprint sensor utilizing a semiconductor element such as a complementary metal-oxide semiconductor (CMOS). The image acquired by the fingerprint sensor 110 may include a blank area as well as a fingerprint area depending on the contact of the finger. To further clarify the present invention, the term ‘fingerprint image’ herein refers to an image acquired by the fingerprint sensor 110 when a fingerprint is placed on the fingerprint input window 111 and provided to the control unit 170, and the term ‘fingerprint area’ refers to a fingerprint image excluding a blank area.

The memory 130 stores pre-enrolled fingerprint data of a user for use in fingerprint recognition, in which the fingerprint data may include data about minutiae points extracted from the fingerprint image.

The display unit 150 displays error or guide information during the process of inputting fingerprints for fingerprint registration or fingerprint authentication under the control of the control unit 170.

The control unit 170 controls the overall operation of the fingerprint recognition apparatus 100, and implements the fingerprint registration using the fingerprint sensor 110, and the fingerprint authentication based on the enrolled fingerprint data.

The control unit 170 determines if the fingerprint image is adequate before extracting the fingerprint data from the fingerprint image provided from the image sensor 110, and displays error and guide information through the display unit 150 if the control unit 170 determines the fingerprint image is inadequate for registration. The control unit 170 provides information to enable an inexperienced user to input a better quality fingerprint images. A good quality fingerprint image leads to a good quality fingerprint data, thereby bringing about an increased authentication success rate and a decreased authentication error rate during the fingerprint authentication process. The term ‘adequate for registration’ herein may mainly refer to the conditions in which the size of the fingerprint area of the fingerprint image provided from the fingerprint sensor 110, the position of the fingerprint area of the fingerprint image, the contact of the fingerprint, or the conditions of the minutiae points based on the user's fingerprint, are within a predetermined range. In other words, the term ‘adequate for registration’ refers to a condition of a fingerprint image from which good quality minutiae point data is possibly extracted.

The control unit 170 may check a fingerprint area size, a fingerprint area position, fingerprint contact or minutiae points of the fingerprint in sequence or in parallel, and may provide a user with the result simultaneously or sequentially.

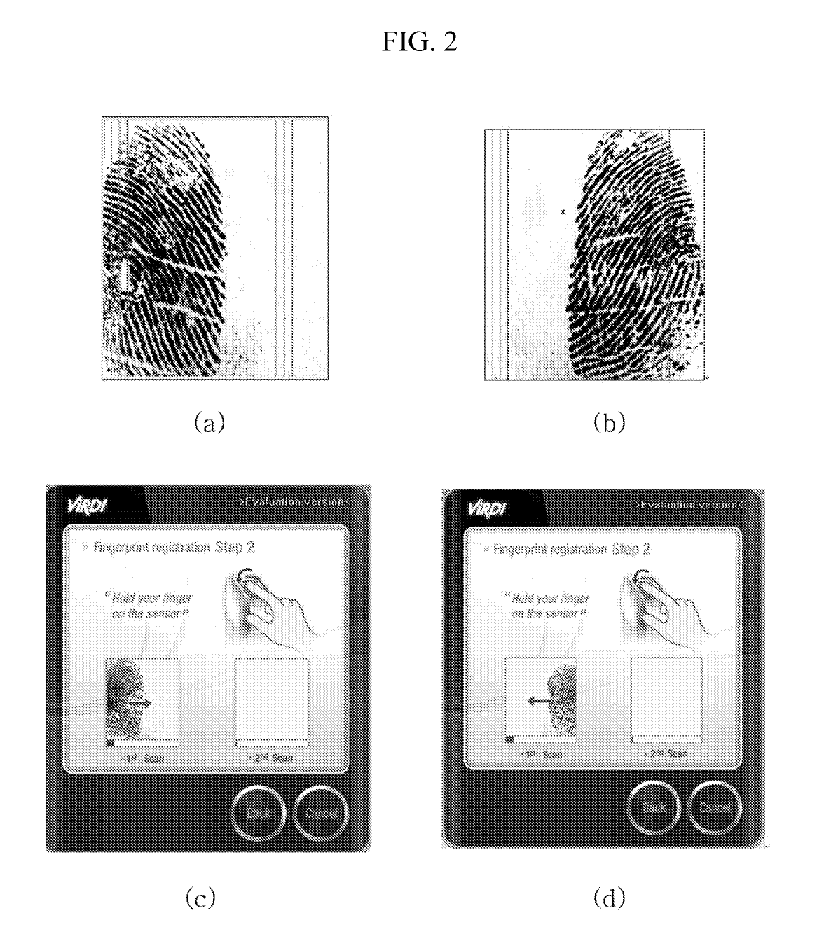

Referring to FIGS. 2 to 5, the quality of the fingerprint image and displaying of the error information will be explained below, in which FIGS. 2 to 5 illustrate a display unit displaying errors of the acquired fingerprint images during the fingerprint registration process.

### Assessing a Position of a Fingerprint Area

FIGS. 2A to 2B illustrate fingerprint images acquired by the image sensor 110, in which FIG. 2A illustrates a fingerprint image acquired when a fingerprint is pushed towards a left side of the fingerprint input window 111, and FIG. 2B illustrates a fingerprint image acquired when a fingerprint is pushed towards a right side of the fingerprint input window 111. In general, because the fingerprint input window of a recognition device is smaller than fingerprints of a whole finger, the fingerprint touched on the fingerprint input window 111 is often pushed towards one side rather than placed on a center of the fingerprint input window 111, resulting in partial images different from one another, and a low success rate of the authentication process.

To prevent the acquisition of a partial fingerprint image and to provide guide information regarding the partial fingerprint image, the control unit 170 first extracts the fingerprint area 2a from the fingerprint image of FIG. 2A provided from the fingerprint sensor 110, and generates the central coordinates of the fingerprint area by calculating a mean value of each pixel coordinate of the extracted fingerprint area 2a.

If the difference between the central coordinates of the extracted fingerprint area 2a and the central coordinates of the fingerprint image of FIG. 2A is placed out of a predetermined range, the control unit 170 may cause the display unit 150 to display information regarding a direction of deviation of the fingerprint position based on the difference of the central coordinates. FIG. 2C illustrates an example in which the display unit 150 displays the information determination by the control unit 170, if a fingerprint image (a) of FIG. 2A is input. Specifically, the display unit 150 displays the first scan image and requests a user to move a finger to the right side and re-input the fingerprint. FIG. 2D illustrates an example in which the display unit 170 displays information determined by the control unit 170, if the finger image (b) of FIG. 2B is input.

### Assessing a Size of a Fingerprint Area

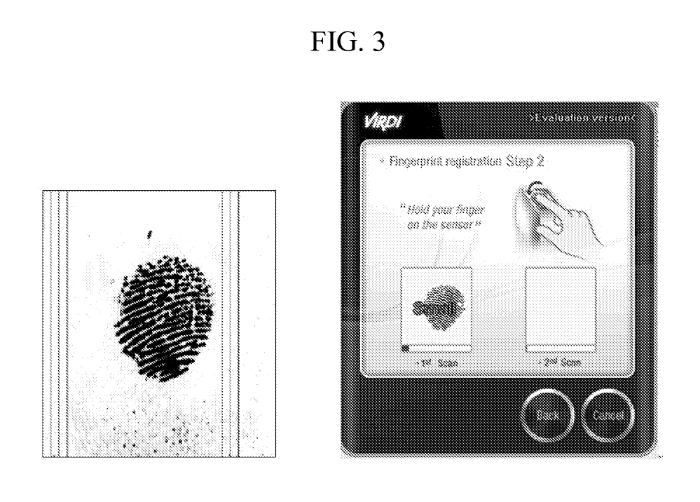

The control unit 170 may additionally cause the display unit 150 to display a ratio of the fingerprint area and request re-input of the fingerprint, if the ratio of the fingerprint extracted from a whole fingerprint image is placed out of a predetermined range. FIG. 3 illustrates an example of a fingerprint image which is smaller than a predetermined size, and an example in which the display unit 150 displays a textual sign ‘small’ indicating that the fingerprint is smaller than the predetermined size. If the fingerprint area input during a registration process is smaller than predetermined, the area for matching is limited and thus success rate is decreased in the authentication process.

### Assessing a Quality of Minutiae Points

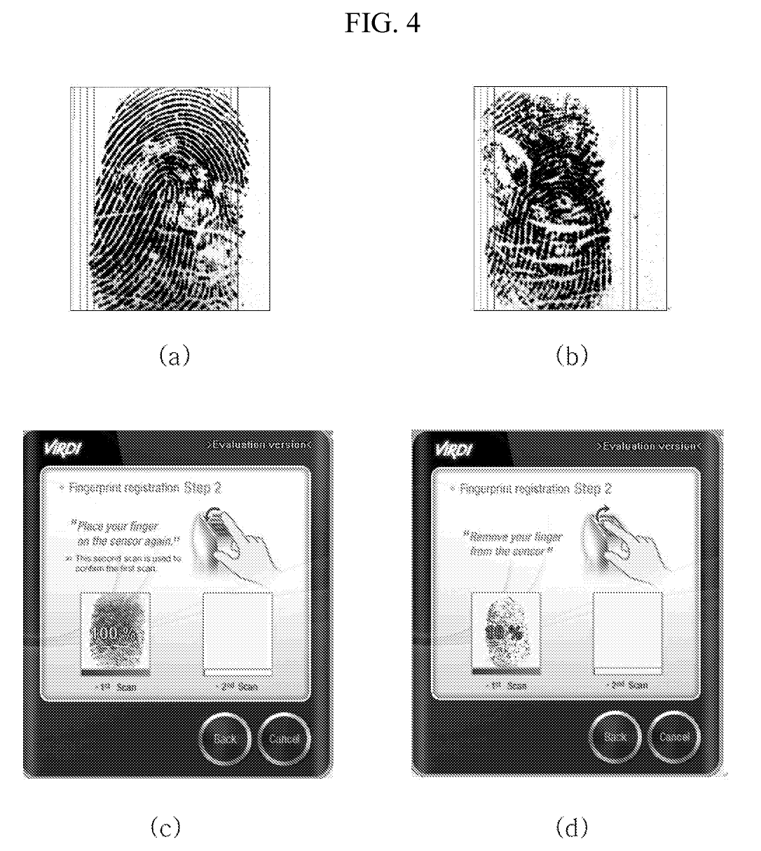

FIG. 4A illustrates a fingerprint suitable for registration, while FIG. 4B illustrates a fingerprint unsuitable for registration.

The control unit 170 assesses the quality of the fingerprints based on the quality (condition) of the fingerprint, such as creases or cuts on the ridges, and causes the display unit 150 to display numerical values representing the assessments. In general, such quality of the fingerprint area may be represented based on the condition or number of minutiae points.

The control unit 170 may determine the quality of the fingerprint area in various ways, and desirably, may detect the conditions of the minutiae points which are the important indicators to consider in the fingerprint recognition. As in FIG. 4B, if fingerprints have the creases or cuts on the ridges, the number of the minutiae points that can be extracted from the fingerprint image may be different from the number of the minutiae points extractable from the better quality fingerprint image. By way of example, the number of a good quality fingerprint is within a predetermined reference range. However, if there are too many creases or cuts on the ridges of the fingerprint, the number of the minutiae points extracted may not reach, or exceed the predetermined reference range. In general, it is considered that there are more improper minutiae points in a fingerprint image, if the number of minutiae points exceeds the predetermined reference range. Again, considering that the number of minutiae points varies depending on how accurately the user inputs his fingerprint image, the importance of the accurate fingerprint input is reemphasized.

Accordingly, the fingerprint quality may be assessed by determining if the number of extracted minutiae points is within a reference range which ensures a desired authentication rate.

Specifically, the control unit 170 may first extract the fingerprint area from the fingerprint image, extract the whole minutiae points (including both adequate and inadequate minutiae points), determine if a difference ratio between the number of the adequate minutiae points and the number of inadequate minutiae points is within a reference range, and represent the result of determination based on numeric values. The following mathematical expression is one of the examples to calculate numerical quality value of the fingerprint:

$$Quality value = \frac{( A \times {f}_{p} ) - ( B \times {f}_{n} )}{{f}_{T}} \qquad [ Mathematical expression 1 ]$$

where, f_{T} is the number of the whole minutiae points, fₚ is the number of adequate minutiae points, and fₙ is the number of inadequate minutiae points.

Weights A and B vary depending on f_{T}. If f_{T} is within a reference minutiae number range, which represents the desired number of minutiae points empirically obtained from a desired quality fingerprint image, the weights A and B have the same value.

If f_{T} exceeds the reference minutiae number range, the control unit 170 may modulate B to be smaller than A, because it is highly possible that a user's fingerprint has a problematic quality rather than there is a problem in the contact or acquisition of a fingerprint image.

On the contrary, if f_{T} is less than the reference minutiae number range, the control unit 170 may modulate the weight B to be larger than weight A.

The control unit 170 causes the display unit 150 to display the resultant quality value of the fingerprint image obtained based on mathematical expression 1, and request a user to reinput if the quality value is not within a predetermined range. FIGS. 4C and 4D illustrate examples in which the display unit 150 displays the quality values of the fingerprint as input. Particularly, FIG. 4D illustrates an example of displaying the quality value of 10%, which represents a relatively poorer quality of the fingerprint image, along with a request for a reinput.

### Assessing a Contact of a Fingerprint

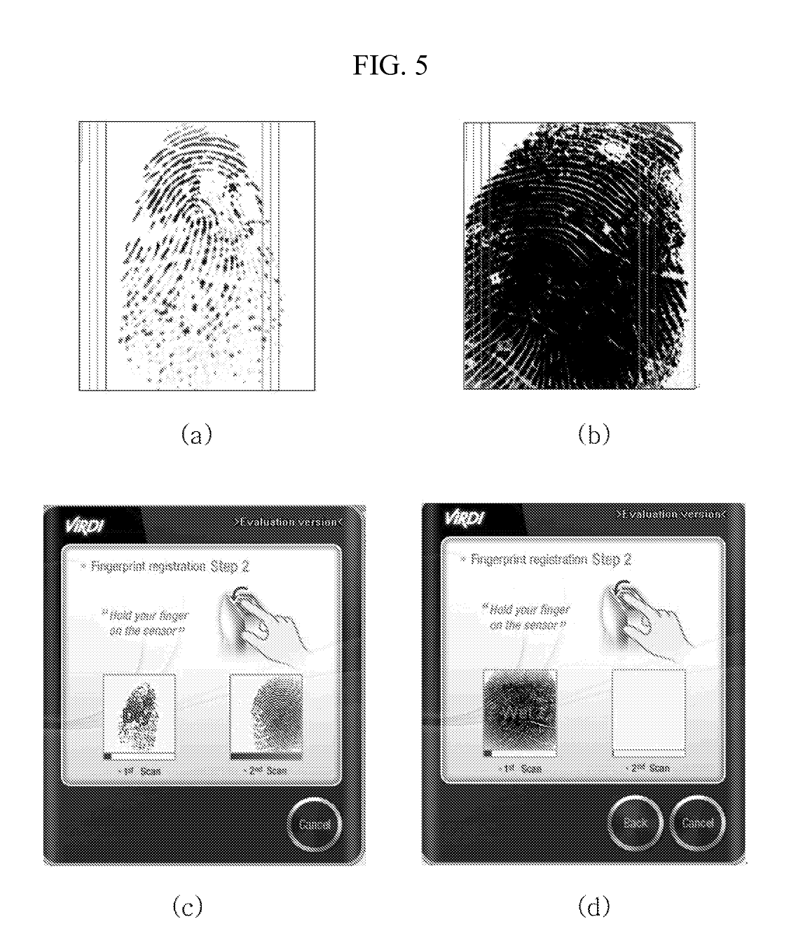

Grey tone of the fingerprint area varies according to the degree of contact of the fingerprint against the fingerprint input window 111. FIG. 5A illustrates an example of an error state, in which degree of contact (or humidity) of the fingerprint is less than a reference range, and FIG. 5B illustrates another example of an error state, in which the degree of contact (or humidity) of the fingerprint exceeds the reference range.

The degree of contact of the fingerprint depends on the fingerprint humidity, the fingerprint pressure, or the skin condition. In the case where the optical sensor is utilized, the fingerprint image quality is particularly influenced by the degree of contact.

Referring to FIG. 5A, if the contact degree is low, the input fingerprint image may have a poor grey tone, ambiguous boundary between fingerprint and background areas, or representation of the ridges in an inadequate stitch form, resulting in badly damaged minutiae point data. Referring to FIG. 5B, if the contact degree is higher than necessary, a gap between ridges may be shortened or lost, or the resultant image may have a high grey tone, in which case the minutiae point data may disappear and the fingerprint authentication rate may decrease.

In terms of the image quality, the grey tone of the fingerprint area varies according to the contact degree. Accordingly, the contact degree of the fingerprint may be computed by utilizing the grey tone of the extract fingerprint area, or simply by determining if a mean value of the whole fingerprint grey tone is within a reference range. However, simply calculating the mean value of the whole fingerprint grey tone may not deal with the exceptional cases such as an example in which the overall gray tone is within the reference range despite of certain portions with extremely high or low gray tones.

As an alternative way, the control unit 170 may divide the extracted fingerprint area into unit segments, calculate grey tone of each unit segment, and calculate the number (x1) of the unit segments whose the grey tone is within the reference range, the number (x2) of unit segments whose the grey tone exceeds the reference range, and the number (x3) of unit segments whose grey tone is insufficient for the reference.

The control unit 170 may determine that the contact is adequate if (x1) is equal to or greater than 50% of the whole unit segments, determine that the contact is wet if (x1) is lower than 50% of the whole unit segments and (x2) is greater than (x3), or determine that the contact is dry if (x1) is lower than 50% of the whole unit segments and (x2) is lower than (x3).

By way of example, the control unit 170 may set the reference level from 40 to 50, if the level of the fingerprint area grey tone is set from 0 to 100. If the fingerprint area extracted from the fingerprint image in FIG. 5A is divided into 50 unit segments, (x1) is lower than 25, and (x3) is greater than 25. Thus, the control unit 170 determines the contact in FIG. 5A to be inadequate, and displays “dry,” as in FIG. 5C, through the display unit 150.

Providing inadequate fingerprint image encourages a user to increase the degree of contact by blowing on his fingers or giving a little bit of humidity if the contact is dry, or to decrease the degree of contact by wiping his fingers or lessening input pressure if the contact is wet. Accordingly, the control unit 170 guides a user to input an optimized fingerprint image and provide optimized fingerprint data.

The control unit 170 may sequentially implement assessment of a position, a size, a quality, or the contact of the fingerprint area explained above, and display error information through the display unit 150 whenever one of the steps fails. Alternatively, the control unit 170 may implement the assessments in sequence or in parallel, and provide all the error information at the same time.

The fingerprint recognition apparatus according to an embodiment of the present invention may acquire a fingerprint image of a corrected quality if determining an input fingerprint image or a quality of the fingerprint area acquired during a fingerprint input process to be inadequate, by providing a user with detailed corresponding error information, along with guide information to solve the error. As a result, the authentication success rate increases and the authentication error rate decreases.

The above features according to an embodiment of the present invention are distinct from the conventional technologies which suffer decreased authentication success rate since the authentication failure is simply notified to the user or an inadequate fingerprint is accepted and processed.

As a result, according to an embodiment of the present invention, it is possible to eliminate the drawbacks such as decreasing authentication success rate or increasing authentication error rate by providing guide information about an input error to the user to help the user to reinput a better quality fingerprint image, instead of simply accepting and processing inadequate quality fingerprint images and acquiring fingerprint data therefrom.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A fingerprint recognition apparatus which comprises a fingerprint sensor to acquire a fingerprint image from a fingerprint placed on a fingerprint input widow, and extracts fingerprint data based on the fingerprint image, the fingerprint recognition apparatus comprising:
a display unit which visually displays predetermined information; and
a control unit which receives the fingerprint image from the fingerprint sensor and extracts the fingerprint data accordingly, and if one of a fingerprint size, a fingerprint position, a degree of fingerprint contact, and a condition of minutiae points is not within a predetermined range, causes the display unit to display guide information including information about a corresponding error and instruction regarding a reinput of the fingerprint.

2. The fingerprint recognition apparatus of claim 1, wherein the control unit determines a size of a fingerprint area based on the fingerprint image, and if the fingerprint area exceeds the predetermined range, causes the display unit to display a corresponding size ratio as the error information regarding the fingerprint size.

3. The fingerprint recognition apparatus of claim 1, wherein the control unit extracts a fingerprint area from the fingerprint image, generates center coordinates of the fingerprint area by computing a mean value of coordinates of each pixel of the extracted fingerprint area, and if a difference between the center coordinates of the fingerprint area and the center coordinates of the fingerprint image is not within the predetermined range, causes the display unit to display the position of the fingerprint extracted from the difference, as the error information regarding the fingerprint position.

4. The fingerprint recognition apparatus of claim 1, wherein the control unit extracts a fingerprint area from the fingerprint image, extracts all minutiae points, including both adequate and inadequate minutiae points, from the extracted fingerprint area, and if a ratio of the inadequate minutiae points in relation to the adequate minutiae points does not satisfy the predetermined range, causes the display unit to display a corresponding ratio as the error information regarding the condition of the minutiae points.

5. The fingerprint recognition apparatus of claim 1, wherein the control unit extracts a fingerprint area from the fingerprint image, divides the extracted fingerprint area into predetermined unit segments, obtains a gray tone of each unit segment, obtains the number (x1) of the unit segments with the gray tones corresponding to a reference level, the number (x2) of the unit segments with the gray tones exceeding the reference level, the number (x3) of the unit segments with the tray gone insufficient for the reference level, determines the degree of fingerprint contact to be higher than the predetermined range if (x1) is short from 50% of the total number of the unit segments and higher than (x2) and (x3), determines the degree of fingerprint contact to be lower than the predetermined range if (1) is short from 50% of the total number of the unit segments and lower than (x2) and (x3), and accordingly causes the display unit to display the error information regarding the degree of fingerprint contact.

6. A method of acquiring a fingerprint image of a fingerprint recognition apparatus which registers a fingerprint using a fingerprint image acquired from a fingerprint placed on a fingerprint input window, the method comprising:
acquiring the fingerprint image from the fingerprint placed on the fingerprint input window;
computing a value representing a fingerprint size, a fingerprint position, a degree of fingerprint contact, and a condition of minutiae points, based on the fingerprint area extracted from the fingerprint image;
if one of the computed values is not within a predetermined range, displaying through a display unit corresponding error information and guide information regarding a reinput of the fingerprint; and
if all of the computed values are within the predetermined range, acquiring the fingerprint data from the fingerprint image.

7. The method of claim 6, wherein the computing comprises obtaining a size of the fingerprint area from the fingerprint image, and
the displaying comprises displaying through the display unit the error information regarding the fingerprint size using a ratio, if the size of the fingerprint area exceeds the predetermined range.

8. The method of claim 6, wherein the computing comprises extracting a fingerprint area from the fingerprint image, generating center coordinates of the fingerprint area by computing a mean value of coordinates of each pixel of the extracted fingerprint area, and obtaining a difference between the center coordinates of the fingerprint area and the center coordinates of the fingerprint image, and
the displaying comprises displaying through the display unit the error information regarding the fingerprint position based on the position of the fingerprint extracted from the difference, if the difference is not within the predetermined range.

9. The method of claim 6, wherein the computing comprises extracting a fingerprint area from the fingerprint image, extracting all minutiae points, including both adequate and inadequate minutiae points, from the extracted fingerprint area, and
the displaying comprises, if a ratio of the inadequate minutiae points in relation to the adequate minutiae points does not meet with the predetermined range, displaying through the display unit a corresponding ratio as the error information regarding the condition of the minutiae points.

10. The method of claim 6, wherein the computing comprises extracting a fingerprint area from the fingerprint image, dividing the extracted fingerprint area into predetermined unit segments, obtaining a gray tone of each unit segment, obtaining the number (x1) of the unit segments with the gray tones corresponding to a reference level, the number (x2) of the unit segments with the gray tones exceeding the reference level, and the number (x3) of the unit segments with the tray gone insufficient for the reference level, and
the displaying comprises determining the degree of fingerprint contact to be higher than the predetermined range if (x1) is short from 50% of the total number of the unit segments and higher than (x2) and (x3), determining the degree of fingerprint contact to be lower than the predetermined range if (1) is short from 50% of the total number of the unit segments and lower than (x2) and (x3), and displaying through the display unit the error information regarding the degree of fingerprint contact.
